(19) United States
(12) Patent Application Publication
(10) Pub. No.: US 2013/0286021 A1
(43) Pub. Date: Oct. 31, 2013

(54) SYSTEMS AND METHODS FOR ANALYZING GRAPHS AND/OR PHYSICAL BODIES

(71) Applicants: Alaeddine Mokri, Abu Dhabi (AE); Mahieddine Emziane, Abu Dhabi (AE)

(72) Inventors: Alaeddine Mokri, Abu Dhabi (AE); Mahieddine Emziane, Abu Dhabi (AE)

(73) Assignee: Masdar Institute of Science and Technology, Abu Dhabi (AE)

(21) Appl. No.: 13/459,996

(22) Filed: Apr. 30, 2012

(51) Int. Cl. G06T 11/20

(52) U.S. Cl. 345/440

(57) ABSTRACT

Systems and methods for analyzing graphs and/or physical bodies are described. In some embodiments, the systems and methods determine one or more scaling factors that may be subsequently used to extract data from a graph/body under consideration. The systems and methods may also enable data extraction from multiple graphs, providing avenues to simultaneously optimize multiple variables at the same time.

### BACKGROUND

Scientists and engineers frequently utilize charts, graphs and the like (collectively, “graphs”) to present and interpret data. In many cases, one or more graphs are included in a scientific document, such as a journal article, book, research paper, or the like. While presenting data in a graph can be useful for justifying conclusions or observations presented in the document subsequent use of graph can be difficult.

For example, a scientist or engineer may wish to use a printed copy of a graph to assist with their research or to further analyze the information presented in a publication in which the graph is included. To this end, the scientist or engineer might use rudimentary implements such as a pencil and ruler to read individual data points from the printed graph. This method can be time consuming and inaccurate, and does not allow mathematical operations (e.g., surface area under a curve, the distance between two points, extrapolation, interpolation, etc.) to be easily and rapidly performed on the data represented by the printed graph.

With the advent of modern computing techniques, scientific publications are increasingly being produced and distributed electronically. Like their hard copy counterparts, electronic publications frequently include graphs. Likewise, mechanisms exist for scanning an image of a printed graph into an electronic format. Thus, electronic images of graphs are now widely produced and distributed in any number of image file formats. For simplicity, a graph that is presented electronically is referred to herein as an “electronic graph.”

Like printed graphs, a scientist or engineer may have difficulty analyzing or using electronic graphs. In many cases, an electronic graph is provided as an image file that does not include the raw data utilized to generate the electronic graph. As a result, it may be difficult to obtain accurate data from the electronic graph itself. Although digitization programs exist to convert an electronic graph to raw data, such programs can be expensive and can take significant time to execute. They may also lack certain functionality, such as the ability to perform on the fly calculations on data represented in an electronic graph.

Finally, graphs encountered in engineering and the sciences often have two independent axes (i.e., two variables). Graphs with greater than two axes can be difficult to produce, and can be more difficult to extract data from than a two dimensional graph. This can be a significant hindrance in fields where the analysis and/or optimization of greater than two variables is desired.

### BRIEF DESCRIPTION OF THE DRAWINGS

Reference should be made to the following detailed description which should be read in conjunction with the following figures, wherein like numerals represent like parts:

FIG. 1 is a block diagram of an exemplary system in accordance with the present disclosure.

FIG. 2A depicts an exemplary input device in accordance with the present disclosure.

FIG. 2B depicts an exemplary input device including a pointer in accordance with the present disclosure.

FIG. 2C depicts an exemplary input device including an optical sensor in accordance with the present disclosure.

FIG. 3 illustrates a graphical user interface in accordance with the present disclosure.

FIG. 4 illustrates a known psychrometric chart.

FIG. 5 illustrates an example in which a system in accordance with the present disclosure is used to extract data from a psychrometric chart.

FIG. 6 illustrates an example in which a system in accordance with the present disclosure is used to calculate the area of a selected region of a psychrometric chart.

FIG. 7 is a block diagram of an exemplary method in accordance with the present disclosure.

FIG. 8 depicts an example in which a system in accordance with the present disclosure is used to extract data from two different charts.

FIG. 9 depicts an example in which a system in accordance with the present disclosure is used to take measurements from a physical body.

### DETAILED DESCRIPTION

As used herein, the terms “physical body” and “body” are interchangeably used to refer to a physical object. Alther three dimensional objects are particularly envisioned, largely two dimensional objects such as paper are also considered within the scope of the present disclosure.

As used herein, the term, “graph” means data or other information that has been presented in a graphical format, such as a chart, a plot, a graph, combinations thereof, and the like. For the sake of illustration, the present disclosure focuses on the extraction of data from two-dimensional graphs, i.e., graphs with two independent axes each representing one of two variables. However, it should be understood that the systems and methods of the present disclosure are not limited to graphs having two dimensions. Indeed, graphs in any format and illustrating any number of variables may be used. While the present disclosure focuses in part on the analysis and use of printed (i.e., hard copy) graphs, the systems and methods described herein may also be used with electronic graphs, i.e., graphs in electronic format, e.g., as one or more images.

While the present disclosure focuses on the analysis of graphs, embodiments in which physical bodies are analyzed are also contemplated. Accordingly, descriptions herein of how the systems of the present disclosure may be applied to analyze graphs should be considered as equally applying to the analysis of a physical body.

As used herein, the term, “module” includes but is not limited to hardware, circuitry, firmware, software, and/or a combination thereof to perform function(s) and/or action(s) consistent with the present disclosure. Non-limiting examples of hardware include processors, microprocessors, circuits, circuit elements (e.g., transistors, resistors, capacitors, inductors, and so forth), integrated circuits, application specific integrated circuits (ASIC), programmable logic device (PLD) logic gates, registers, semiconductor devices, chips, microchips, chipsets, displays, sensors and so forth. Software components of the modules described herein may take the form of a software package, code, and/or instructions that may be executed by one or more processors. The software components may be accessed locally or remotely through Internet, Intranet, or otherwise. “Circuitry” is used herein to mean, singly or in any combination, hardwired circuitry, programmable circuitry, state machine circuitry, and/or firmware that stores instructions executed by programmable circuitry.

Certain elements and embodiments of the present disclosure may take the form of a computer-readable medium having processor-executable instructions stored thereon, which when executed by a processor cause the processor to perform stated functions. Examples of computer-readable media include but are not limited disks, such as floppy disks, optical disks, compact disk read-only memories (CD-ROMs), compact disk rewritables (CD-RWs), magnetic recording media, magneto-optical disks, semiconductor devices such as read-only memories (ROMs), random access memories (RAMs) (e.g., dynamic and/or static RAMs), erasable programmable read-only memories (EPROMs), electrically erasable programmable read-only memories (EEPROMs), solid state memories (e.g., flash), magnetic or optical cards, or any type of tangible media suitable for storing electronic instructions. The instructions may include any suitable type of code and may be implemented using any suitable programming language

One or more elements of the present disclosure may form all or a part of a computing device. Exemplary computing devices include but are not limited desktop computers, laptop computers, smartphones, cell phones, tablet personal computers, personal data assistants, combinations thereof, and the like. For the sake of brevity, such devices are collectively referred to herein as a “computer” or “computing device.” Such computing devices may include any suitable processing platform, device or system, any suitable computing platform, device or system and may be implemented using any suitable combination of hardware and/or software.

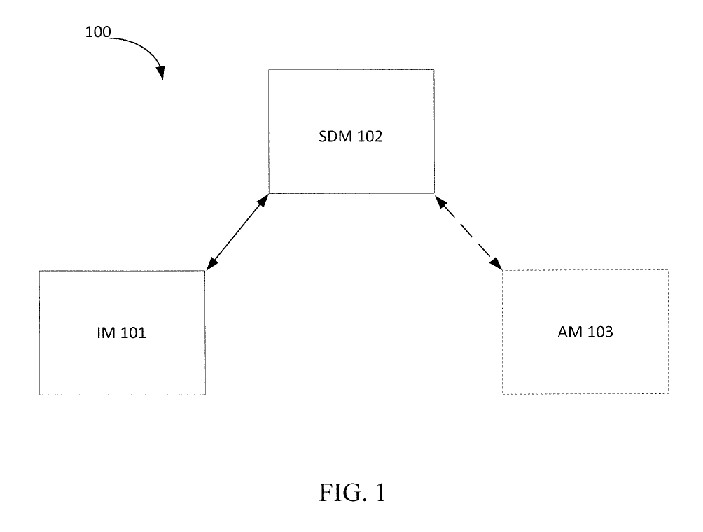

One aspect of the present disclosure relates to systems for analyzing graphs and/or physical bodies. In general, such systems include at least one input module (“IM”) and at least one synchronization and display module (“SDM”). The systems may optionally further include at least one analysis module (“AM”). In this regard, reference is made to FIG. 1, which depicts an exemplary system in accordance with the present disclosure. As shown, system 100 includes input module (“IM”) 101 and synchronization and display module (SDM) 102. Analysis module (“AM”) 103 may also be included, and is shown with hashed markings to indicate its optional status.

IM 101 can function to provide the physical position of at least one input device to SDM 102. As the input device is moved, SDM 102 can monitor the position of the input device, as well as the position of a digital pointer that is rendered on a display. SDM 102 can then determine one or more scaling factors that can be used to scale the movement of the digital pointer to the movement of the input device. Once SDM 102 has determined such scaling factor(s), data may be extracted from a graph/body under consideration. Data extraction may occur, for example, by tracing or otherwise following features of the graph/body with an input device and/or the digital pointer, and applying the scaling factor(s) to convert the position of the input device/digital pointer to corresponding data values. Synchronously or asynchronously with such data extraction, optional AM 103 may perform one or more mathematical calculations on the extracted data.

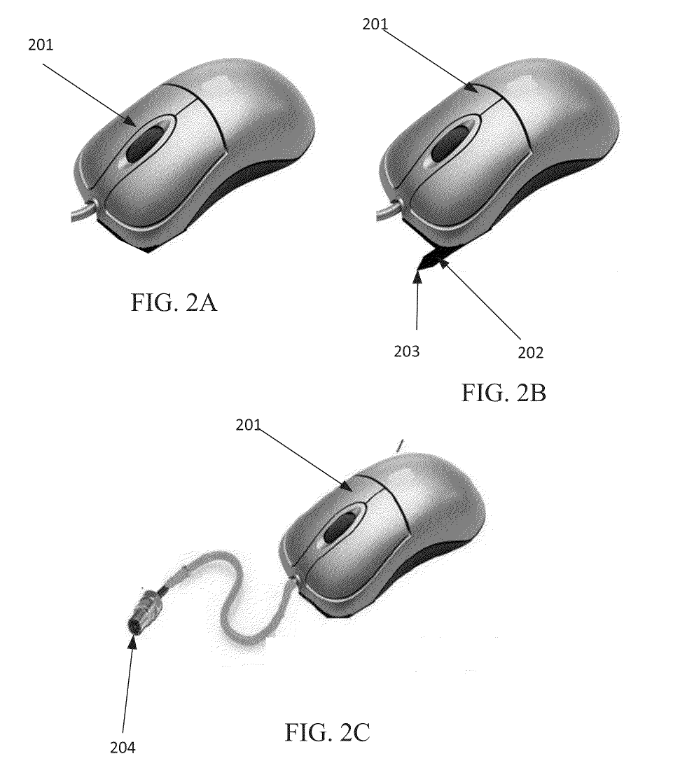

IM 101 can include at least one input device. While the present disclosure focuses on the use of a computer mouse as an input device, it should be understood that any device that is capable of physically tracing or otherwise following features of a graph may be used. Non-limiting examples of suitable input devices include a computer mouse, a trackball, a touchpad, a touch screen, a stylus, a game controller, a gamepad, a paddle, a joystick, a remote control, a video input device (e.g., web camera, digital camera, etc.), smartphones, tablet personal computers, personal data assistants, combinations thereof, and the like. In non-limiting embodiments, and as illustrated in FIGS. 2A and 2B, IM 101 includes a mouse 201 as an input device. In such instances, the graph under consideration may be provided, for example, as an image on a mouse pad or other surface over which the input device may be moved.

The input device may include one or more features to enhance accuracy and/or to aid in the tracing of features of a graph under consideration. Non-limiting examples of such features include pointers, cross hairs, markings, light sources (e.g., a laser, a light emitting diode, a light bulb, etc.) providing marking indicia such as a line, a spot, a cross, etc., combinations thereof, and the like. FIG. 2B shows a non-limiting illustration of this concept, wherein mouse 201 is equipped with targeting device 202. In this embodiment, targeting device 202 is configured as a sharp pointer integral with or attached to the body of mouse 201. In operation, all or a portion of targeting device 202 (e.g., tip 203) may be used to trace or otherwise follow features of a graph under consideration while physically moving mouse 201.

FIG. 2C depicts another example of an input device that includes features to enhance accuracy and/or aid in the tracing features of a graph or physical body. In this embodiment, a optical sensor 204 is attached to mouse 201 by way of a cable, not labeled. Sensor 204 may be moved over an graph or object in question in much the same manner as mouse 201 including pointer 203 may be moved.

IM 101 can function to send one or more signals indicative of the position and/or movement of the input device to SDM 102. Communication between IM 101 and SDM 102 may occur in any suitable manner, using any suitable communications interface. For example, IM 101 and SDM 102 may be in wired or wireless communication with one another. In the former case, IM 101 and SDM 102 may communicate, for example, using the well-known universal serial bus (USB) and/or personal system 2 (PS/2) interfaces. In the latter (wireless) case, IM 101 and SDM 102 may communicate via one or more wireless communication interfaces, such as a wireless network, a personal area network, a BLUETOOTH™ network, near field communication (NFC), radio frequency communication, combinations thereof, or the like.

IM 101 may communicate information about the input device's position and/or movement in a number of different ways. For example, IM 101 may communicate signals to SDM 102 that include one or more indicators of the position of the input device, e.g., physical coordinates corresponding to the position of the input device at a set time. Such coordinates may be, for example, X and Y coordinates of a two dimensional Cartesian coordinate system. Alternatively or additionally, IM 101 may transmit signals that are indicative of the movement of the input device in two dimensions, but which may not correspond to a specific physical location. For example, IM 101 may transmit signals indicating movement and/or speed of the input device in a particular direction, which may be applied to cause a digital pointer to move in a corresponding fashion.

In some embodiments IM 101 includes machine executable input module instructions that when executed by a processor cause the processor to transmit information regarding the position and/or movement of the input device to SDM 102. Such input module instructions may, for example, take the form of one or more device drivers, system libraries, combinations thereof, and the like. Of course, such formats are exemplary only, and IM 101 may include input module instructions in any suitable form. Indeed, input module instructions in the form of one or more applications, web based applications (web-app), browser plugins, and the like are envisioned, and are suitable for use in the present disclosure.

SDM 102 can function to cause a computing system to render a graphical user interface (GUI) on a display. SDM 102 may include machine readable GUI instructions for this purpose. In such instances, the GUI instructions when executed by a computing system (or a processor thereof) cause the computing system to render a GUI on a display thereof. Such GUI instructions may take the form of an independent application that is executed by a computing system or a processor thereof. Alternatively or additionally, the GUI instructions may take the form of a web-based application, i.e., an application run within a host web browser. Thus for example, the GUI instructions may take the form of website code that is executed and/or read within a web browser. In such instances, the GUI produced by SDM 102 is referred to herein as a web-based graphical user interface (WBGUI). Regardless of its nature, the GUI may be understood to provide an interface for extracting data from a graph, reporting that data and, in some instances, displaying an image of the graph under consideration.

The GUI instructions may be coded using any suitable programming language, such as but not limited to hypertext markup language (HTML), Java™, Adobe™, Flash™ combinations thereof and the like. In non-limiting examples, SDM 102 includes machine readable instructions coded in HTML, JavaScript™ or a combination thereof, which when executed by a computing device (or processor thereof) cause a WBGUI to be rendered on a display.

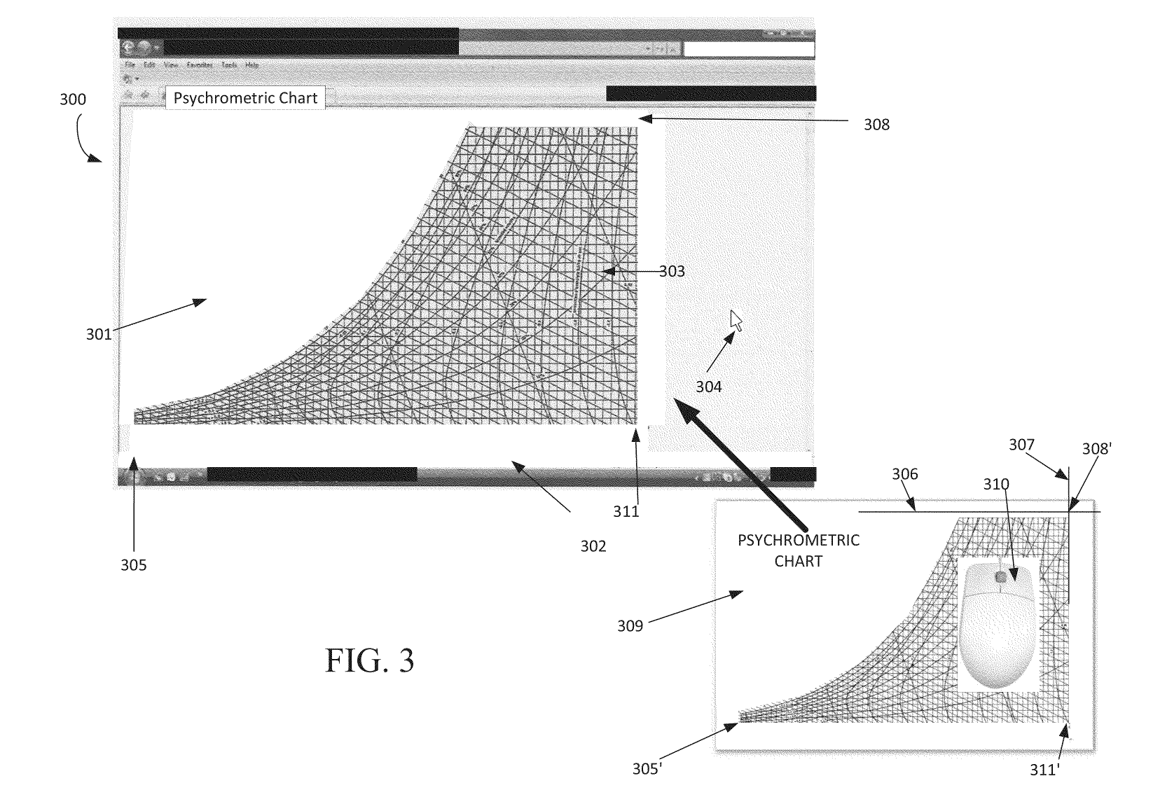

FIG. 3 depicts one non-limiting example of a WBGUI consistent with the present disclosure. As shown, WBGUI 300 includes rendering area 301 and optional reporting area 302. Although not required, rendering area 301 can function to display an image 303 of a graph under consideration, in this case printed graph 309. If included, the image of the graph may be in any format, such as in .JPG, .GIF, .BMP, .PDF, .TIFF, another image format, or the like.

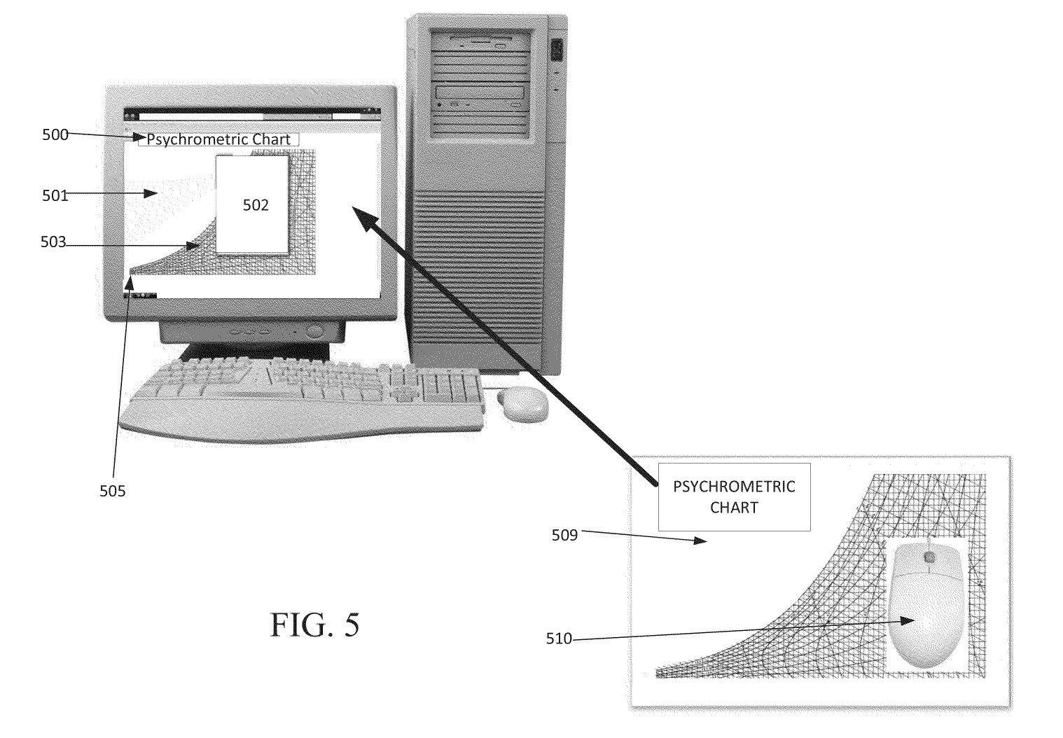

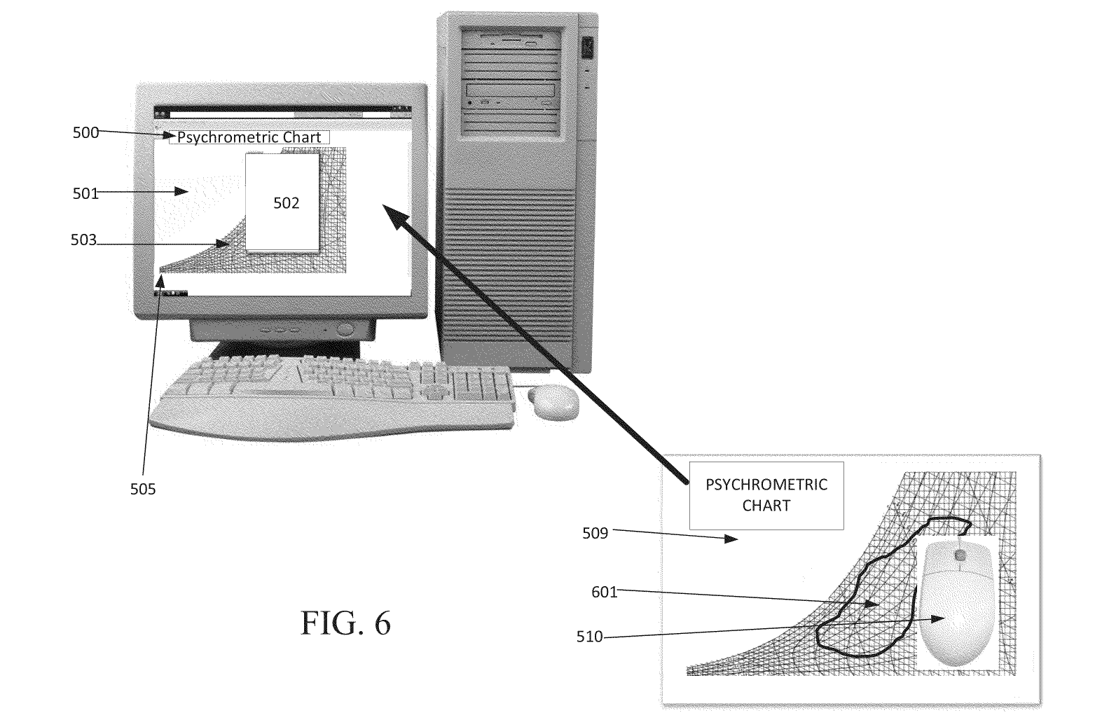

Optional reporting area 302 may function to display information relevant to the graph under consideration. For example, reporting area 302 may display raw coordinates of digital pointer 304, data extracted from graph 309, and/or the results of an analysis performed by optional analysis module 103. While reporting area 302 is shown in FIG. 3 as a frame within WBGUI 300, such a format is not required. Indeed, reporting area 302 may be configured as an alert or pop-up window that appears in response to the selection and/or rollover of all or a portion of the graph under consideration. This concept is reflected in FIGS. 5 and 6. Alternatively or additionally, information relevant to the graph under consideration may be displayed within rendering area 301.

Digital pointer 304 is a visual or non-visual indicator that may be used to point to or otherwise reference features within a GUI, e.g., WBGUI 300. In one embodiment, and as shown in FIG. 3, digital pointer 304 may take the form of a cursor, such as a mouse cursor. This form is exemplary only, and it should be understood that digital pointer 304 may take any suitable form.

Digital pointer 304 may synchronously or asynchronously move in response to movement of input device 310. That is, as input device 310 moves in a direction, digital pointer 304 may move in the same direction within WBGUI 300. In some instances, however, digital pointer 304 may not move at the same speed as the input device. For example, digital pointer 304 may move in units corresponding to the resolution of rendering area 301 (e.g., in pixels), whereas input device 310 may move in different units. To enable data extraction from graph 310, SDM 102 can function to scale the movement of digital pointer 304 to the movement of input device 310.

More specifically, and as will be described below, SDM 102 can determine the number of pixels that digital pointer 304 moves, as input device 310 is moved by a known distance along the axes of graph 310. The relationship between the number of pixels digital pointer 304 moves relative to a known movement of input device 310 is hereinafter referred to as a “scaling factor.” In some embodiments, the scaling factor is the number of pixels of rendering area 301 correlating to a unit (i.e., a known distance) reported on an axis of the graph under consideration. Once SDM 102 determines scaling factors for each axis of a graph under consideration (e.g., the x and y axes of graph 309), it may apply such factors to convert the position of input device 304 to data represented in the graph. The manner in which SDM 102 may determine and apply such scaling factors is described below, with reference to the non-limiting example shown in FIG. 3.

To determine the aforementioned scaling factor(s) for each axis of graph 309, SDM 102 may monitor the position of digital pointer 304, as input device 310 is moved along the x and y axes of graph 309 by a known distance. In some embodiments, SDM 102 monitors the position of digital pointer 304, as input device 310 traces the entire length of each axis of graph 309. After input device 310 traces each axis of graph 309, SDM 102 may determine the corresponding length of each axis in pixels (hereafter, “total pixel length) by determining the difference between the starting and ending pixel coordinates of input device 304. As noted previously, SDM 102 may receive the pixel coordinates of digital pointer 304 from IM 101. SDM 102 may then determine a scaling factor for each axis by dividing the total pixel length of an axis by the number of units reported on that axis. For example, consider a scenario in which SDM 102 determines that the total pixel length of the x axis of graph 309 is 10,000. If the x axis in this scenario includes 10 units, SDM 102 may determine through division that the scaling factor for that axis is 1000 pixels/1 unit.

Alternatively, SDM 102 may determine a scaling factor for each axis of graph 309 by determining the difference in the starting and ending pixel coordinates of digital pointer 304, as input device traces one or more units of such axes. For example, SDM 102 may monitor the pixel coordinates of digital pointer 304 as input device 310 traces the length of one or more units of the axes of graph 309, and applying the following formula:

SF(x,y)=ΔP(x,y)/U(x,y)

where ΔP(x, y) is the difference between the starting and ending pixel coordinates of digital pointer as input device 310 is moved along the relevant axis of graph 309, U is the number of units along the relevant axis of graph 309 that input device 310 was moved, and SF(x, y) is the calculated scaling factor for the relevant axis. If the scaling factor for each axis is determined in this manner, SDM 102 may determine the total pixel length of each axis of graph 309 by multiplying the relevant scaling factor by the number of units reported on the corresponding axis. For example, if scaling factor (x) is 1000 pixels/1 unit of the x axis of graph 309, and graph 309 includes 10 units on its x-axis, the total pixel length of such axis is 10,000 pixels.

Although the foregoing discussion focuses on the derivation of a scaling factor from the total length of an axis or vice versa, it should be understood that such parameters may be independently determined. That is, SDM 102 may calculate a scaling factor for each axis by determining the number of pixels that digital pointer 304 moves in response to the movement of input device 301 by one or a subset of units of each axis of graph 309, as discussed above. In addition, the total pixel length of each axis may be determined by SDM 102 by determining the number of pixels that digital pointer 304 moves in response to the tracing of the entire length of the axes of graph 309, as also discussed above.

In any case, the scaling factor determined by SDM 102 for each axis of a graph under consideration may be associated with the scale of each unit reported on such graph. Thus, for example, if a graph plots time on the y axis versus temperature on the x axis, SF(x) may be reported in pixels/unit temperature (e.g., Celsius, Fahrenheit, etc.), and SF(y) may be reported in pixels/unit time (e.g., seconds, minutes, hours, etc.).

Once scaling factors have been determined for each axis, SDM 102 may extract data from graph 309 by determining the position (i.e., pixel coordinates) of a digital pointer relative to one or more reference points in a rendering area of a GUI, and converting the position of the digital pointer to data using the scaling factor(s) for each axis.

With respect to the reference point(s), one or more locations within a GUI rendering area may be selected to correlate to selected locations on the graph under consideration. In some embodiments, SDM 102 correlates first and second reference points in the rendering area to desired starting and end points for a graph under consideration. When the graph under consideration is a two-dimensional plot, for example, SDM 102 may use the lower left hand corner of the GUI rendering area as a first reference point, and correlate the origin (i.e., the intersection of the X and Y axes) of the graph under consideration with the first reference point. In addition, SDM 102 may utilize upper right hand corner of the GUI rendering area as a second reference point, and correlate an intersection of the furthest parallels to the X and Y axes of the graph under consideration to the second reference point. Of course, additional reference points may also be used. For example, SDM 102 may assign a third reference point to a portion of the rendering area of a GUI. The position of the third reference point may be set so that the number of pixels between the first and third reference points correlates to the total pixel length of an x-axis of a two dimensional graph Likewise, the position of the third reference point may be set such that the distance between the second reference point and the third reference point correlates to the total pixel length of a y axis of a two dimensional plot. In this way, SDM 102 may appropriately scale the rendering area of the GUI, based on the scale of the graph under consideration.

In the non-limiting example shown in FIG. 3, the lower left hand portion of rendering area 301 is identified as first reference (starting) point 305, the upper right hand portion of rendering area 301 (defined by the intersection of lines 306 and 307) is identified as a second reference (ending) point 308, and the lower right hand portion is identified as third reference point 311. First, second, and third reference points 305, 308, 311 correspond to equivalent positions 305′, 308′, and 311′, respectively, of graph 309. As may be appreciated, the distance between the first reference point 305 and third reference point 311 corresponds to the total pixel length of the x axis of graph 309 Likewise, the distance between second reference point 308 and third reference point 311 corresponds to the total pixel length of the y axis of graph 309.

Reference points within rendering area 301 may be set by moving input device 310 to relevant portions of graph 309 and causing SDM 102 to record that position as a reference point. Recording to the position may be instigated by an input made through input device 310, another portion of IM 101, or some other means. Such inputs may include, for example, a mouse click, a button press, a touch on a touchscreen, a voice command, combinations thereof, and the like. Thus, for example, input device 310 may be moved to the origin of graph 309 (i.e., point 305′), and an input (e.g., a mouse click) may cause SDM 102 to record that position as reference point 305 in rendering area 301. Input device 310 may be subsequently moved to other desired positions (e.g., points 308′, 311′) whereupon SDM 102 may record such positions as second reference point 308 and third reference point 311.

In some embodiments, SDM 102 may include instructions that when executed cause digital pointer 304 to be located at a reference point in rendering area 301 when input device 310 is at a corresponding point on printed graph 309, and vice versa. Thus for example, when input device 310 is located at position 305′, digital pointer 304 may be located at reference point 305, and vice versa. Likewise, when input device 310 is located at positions 308′ or 311′, digital pointer 304 may be located point 308′ and 311′, respectively, and vice versa.

In embodiments wherein an image 303 of graph 309 is present in rendering area 301, the reference points utilized may be associated with corresponding points in image 303. This may be accomplished, for example, by appropriately adjusting the size and/or position of image 303. This concept is illustrated in FIG. 3, wherein image 303 has been sized and positioned in such a way that its origin corresponds to the first reference point 305, and the intersection of the furthest parallel lines to its axes correspond to second reference point 308.

As noted previously, SDM 102 may convert the pixel coordinates of a digital pointer in the rendering area of a GUI to data values of a graph under consideration. SDM 102 may perform this conversion, for example, by determining the difference between the pixel coordinates of the digital pointer and the pixel coordinates of a reference point, and applying the scaling factor determined above. For clarity, reference is again made to FIG. 3, wherein first reference point 305 corresponds to the origin (0, 0) of graph 309, and thus may be considered by SDM 102 to have pixel coordinates of (0, 0). In response to movement of input device 310, digital pointer may move to a location within rendering area 301 of WBGUI 300, e.g., to a point having pixel coordinates of (100, 100) (or some other point), relative to reference point 305.

SDM 102 may then convert the pixel coordinates (100, 100) of digital pointer 304 to actual data values in graph 309 by applying the SF(x) and SF(y) (determined above) in the following formula:

DV(x,y)=C(x,y)*1/SF(x)

Where C(x, y) is the x or y pixel coordinate of digital pointer 304, 1/SF(x, y) is inverse of the scaling factor for the relevant axis (e.g., U(x)/ΔP(x), where U is 1 unit of the X axis and ΔP(x) is the number of pixels corresponding to 1 unit of the X axis), and DV (x, y) is the calculated data value for the relevant axis. Thus for example, if C(x) and C(y) are both 100 pixels, 1/SF(x) is 1 Celsius/1000, and 1/SF(y) is 1 second/100 pixels, SDM 102 may calculate the position of digital pointer 304 as correlating to 1 second and 0.1 degrees on graph 309.

As demonstrated above, the systems and methods of the present disclosure can enable rapid and facile data extraction from a printed graph, such as graph 309 in FIG. 3. Indeed, data extraction may be performed by moving an input device 310 over graph 309, resulting in a corresponding movement of digital pointer 304. SDM may then convert the pixel coordinates of the digital pointer 304 (as discussed above) to calculate actual data points corresponding to the position of input device 310. SDM 102 may cause the calculated data values to appear, for example, within reporting area 302 of rendering area 301.

Although not required, SDM 102 may also include instructions that when executed by a processor cause the processor to produce an image reflecting the path of input device 310 as it moves over graph 309. In such instances, features of graph 309 may be reproduced in rendering area 301. For example, where graph 309 is a line graph, input device 310 may trace or otherwise follow one or more lines plotted in the graph. As input device 310 traverses the plotted line, SDM 102 may cause an image of the path of input device 310 to appear ion rendering area 301. In this way, SDM 102 can cause an image of all or a portion of a printed graph under consideration to appear in rendering area 301. The image produced in this manner may, for example, over or underlay a pre-loaded electronic image of the graph under consideration, such as image 303 discussed above.

As discussed above, the systems of the present disclosure can enable the extraction of data from printed graphs. It should be understood, however, that the systems disclosed herein are not limited to such use. For example, the systems described herein may also be used to analyze electronic graphs. In such instances, the systems described herein may calculate or otherwise determine the aforementioned scaling factors by monitoring the change in pixel coordinates of a digital pointer, as it traces all or a portion of the axes of the electronic graph under consideration. The functions of IM 101 and SDM 102 are otherwise largely the same as those discussed above in conjunction with the analysis of a printed graph. Accordingly, the function of IM 101 and SDM 102 in the analysis of electronic graphs is not reiterated herein.

Likewise, the systems of the present disclosure may be used to analyze physical bodies, such as but not limited to geometric shapes. In such instances, SDM 102 may calculate or otherwise determine a scaling factor in the manner described above, and use such scaling factor to normalize the movement of a digital pointer to the movement of an input device. Once relevant scaling factor(s) is (are) determined, SDM 102 may calculate relevant data values by converting the pixel coordinates of a digital pointer to data values as an input device traces or otherwise follows features of the geometric shape/physical body.

As noted above, the systems of the present disclosure may further include analysis module (AM) 103. Generally, AM 103 may include analysis instructions that when executed by a processor cause the processor to perform one or more analytical operations on data extracted from a chart under consideration. For example, AM 103 may perform calculations to determine the distance between points on a graph, the area under a curve, the volume or area of selected area of a graph or body, etc. In some embodiments, AM 103 may also function to determine mathematical expressions (e.g., an interpolation function) to describe features present on a graph under consideration. For example, if a graph under consideration includes a line (e.g., a curve fit), AM 103 may determine mathematical equation describing the curve fit from data extracted from the chart when an input device traces or otherwise follows the line in question. And in still further embodiments, AM 103 may convert data values to other units or relevant data using known conversion factors or mathematical relationships for the data in question.

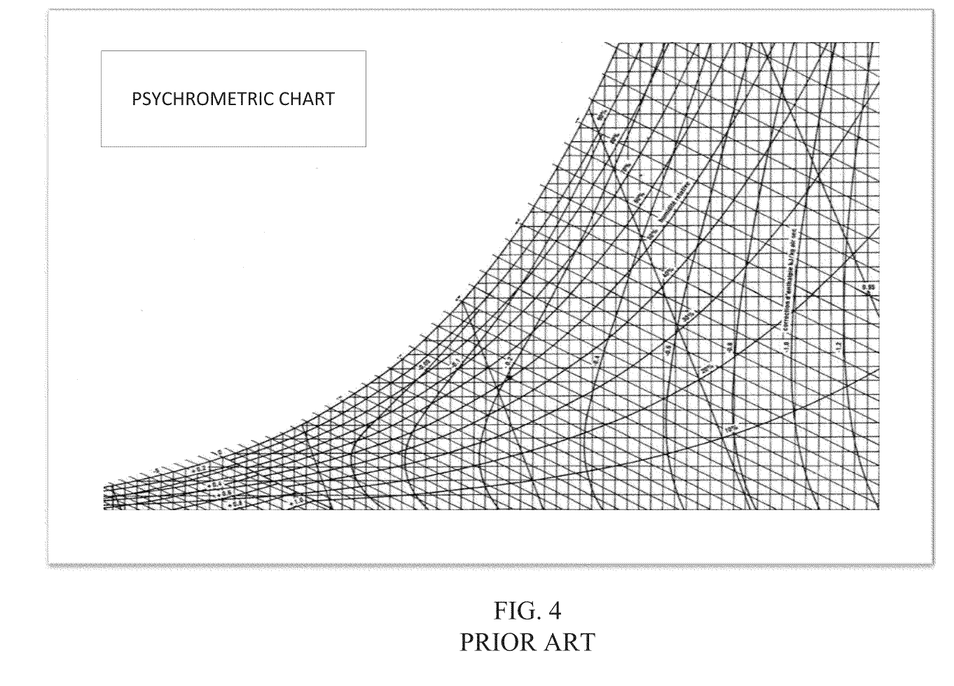

For the purposes of clarity only, the present disclosure will now describe an example wherein data is extracted from a known psychrometric chart, namely the psychrometric chart depicted in FIG. 4. As is known in the art, a psychrometric chart is a graphical representation of physical and thermal properties of moist air, and may be used to calculate air properties at various temperatures, pressures, and moisture content. The psychrometric chart of FIG. 4 includes two orthogonal axes (Pv, T), where Pv is the partial pressure of vapor in millimeters of mercury (mmHg), and T is air temperature in Celsius. The chart also includes numerous other features, such as the saturation curve for air, a curve for equal humidities, a curve of equal relative humidities, and so forth. Such additional features are not relevant to this discussion, and so are not discussed in detail herein.

In many instances, scientists and engineers may use a pencil and ruler to find the coordinates of a point on a psychrometric chart. Using this method is tedious, and does not provide a convenient mechanism for calculating a complex surfaces, extrapolations, interpolations, etc. in the chart. As will be described below, the systems and methods of the present disclosure may enable rapid and facile data extraction and analysis from psychrometric charts.

To extract data from the chart shown in FIG. 4, a digital image of the chart was made, and stored in an appropriate image file format, e.g., a .JPG, .TIFF, .PNG, etc. In this case, the digital image of the psychrometric chart was stored in a .PNG file under the name diagramme.png. An SDM was executed by a processor of a computing device, causing a WBGUI to appear on the display thereof. In this example, the WBGUI was programmed using a combination of HTML and JavaScript. The relevant code is shown below.

```
<HTML>
    <HEAD>
        <TITLE>Electronic Chart </TITLE>
        <!--the title of the webpage-- >
        <SCRIPT LANGUAGE = “JavaScript” src=scripts/electronic
        chart.js”>
    <!--the target to the JavaScript script-->
        </SCRIPT>
    </HEAD>
      <BODY background = “images/diagramme.png”>
<!-target to a digital copy of the chart -->
    </Body> </HTML>
```

For this example, the above code was created using a basic text editing program, such as the Notepad program available in various MICROSOFT™ WINDOW™ operating systems. Of course, other programs (e.g., a website development software package) could be used to generate this code. It should also be understood that statements between “<!-” and “-->” are comments that do not affect the operation of the code.

The JavaScript code (here, electronic chart.js) was written to perform various functions of the SDM described above. For example, the JavaScript included code to determine length of the Pv and T axes of the psychrometric chart shown in FIG. 4. The JavaScript also included code to determine appropriate scaling factors, i.e., the length of 1 unit of each axis in pixels (here, the length in pixels corresponding to 1 mm Hg and 1 Celsius, respectively). Finally, and with reference to FIG. 5, the JavaScript included code that set the origin 505 of the image 503 of psychrometric chart 509 to the origin of rendering area 501 of WBGUI 500. The JavaScript further included code to apply the scaling factors for the Pv and T axes of psychrometric chart 509, so as to convert the location (pixel coordinates) of a digital pointer (not shown) in rendering area to pressure and temperature values. The JavaScript caused the results of that conversion to be displayed in reporting area 502, which took the form of a popup window in this example.

For the sake of interactivity, the JavaScript further included code that caused the properties calculated by the system to be synchronously determined and displayed in reporting area 502, as a digital pointer (again, not shown) was moved over image 503 of graph 509.

However, it should be understood that synchronous reporting of calculated values is not required. Indeed, the JavaScript applied in this example could have been configured to display the calculated results in reporting window 502 in response to an input, e.g., a mouse click.

The system used in this example further included an analysis module to perform one or more calculations on the data extracted in the manner discussed above. As shown in FIG. 6, for example, the analysis module included code that when executed caused a processor to determine the area of a region 601 on graph 509 that was traced by input device 510. The code further causes the calculated area of region 601 to be displayed in reporting area 502.

The analysis module also included code to calculate other properties from the data points extracted from the psychrometric chart. In this case, the analysis module included code to calculate various properties of air from the partial pressure of vapor (Pᵥ) and air temperature (T) information extracted from the graph. In this regard, it is known that the eight properties that describe the state of air (include relative humidity (HR), absolute humidity (x), partial pressure of vapor (Pᵥ), condensation temperature (Tᵣ), equilibrium temperature (Tₕ), air temperature (T), enthalpy (i) and density (p)) are related by six known mathematical equations. In this example, the analysis module was configured to solve these six mathematical relationships, thereby calculating HR, x, Tᵣ, Tₕ, i, and p from one or more of the extracted values of Pᵥ and T.

For example, the analysis module included code to calculate relative humidity (HR) using the following two equations:

Pₛ(t)=exp[46.784−(6435/(T+273.15))−33868ln(T+273.15)]; (1)

HR=(Pᵥ/Pₛ(T))*100 (2)

where Ps(t) is the pressure of saturation in mm/Hg. By inputting the air temperature (T) extracted from the psychrometric chart, the analysis module can solve equation (1) to determine Ps(t). The analysis module can then input Ps(t) and the partial pressure of vapor (Pᵥ) extracted from the psychrometric chart into equation (2) and solve for relative humidity (HR).

The analysis module in this example was configured to provide the results of the above mathematical operation to the JavaScript of the synchronization and display module. The synchronization and display module then caused the calculated results to be displayed in the reporting area of the GUI.

For the sake of illustration, the JavaScipt code (i.e., electronic chart.js) for the analysis of the psychrometric chart of FIG. 4 is provided below. It should be understood that this code is exemplary only, and that other code may be used. It should also be understood that this code includes the code for the synchronization and display module (e.g., SDM 102) and the analysis module (e.g., AM 103) that were used to analyze the psychromteric chart of FIG. 4. Electronic chart.js

```
<!--
    document.onclick = printEvent;
    function printEvent(e)
    {
    m_X = event.screenX;
    m_Y = event.screenY;
    if ( m_X < 27 || m_X > 955 || m_Y > 681 || m_Y < 153 ) <!-- This instruction tests if the
point selected is inside the graph or outside --!>
    {
    alert (“ The point selected is outside the graph. Please select a point from inside the graph
”)
    }
    else {
    m_X = (m_X − 173)/14.1 ;
    m_Y = (680 − m_Y)/15.66 ;
    rho = (1.293*273.15*(18/29)*(1+m_Y/1000))/((m_X+273.15)*((18/29)+m_Y/1000));
    h = 1.006 * (m_X) + (m_Y/1000) * (2501+1.840*(m_Y));
    pv = (1.01325*(m_Y/1000))/((18/29)+(m_Y/1000)) ;
    facteur = 20.3182−2795/(m_X+273.15)−1.68*Math.log(m_X+273.15) ;
    ps = Math.pow(10,facteur) ;
    ps = ps/750.01 ;
    hrm = (pv/ps)*100 ;
    th = 0 ;
    t1 = −50 ;
    t2 = 200 ;
    tr = 0 ;
    for (i = 1 ;i <= 50 ;i++) {
    tl=(t1+t2)/2 ;
    fact = 20.3182−2795/(tl+273.15)−1.68*Math.log(tl+273.15) ;
    pl = Math.pow(10,fact) ;
    pl = pl/750.01 ;
    delta = t2−t1 ;
    if (pl > pv)
    {
    t2 = tl ;
    }
    if (pl <= pv)
    {
    t1 = tl ;
    }
    if ( delta < 0.5 )
    {
    tr = (t1+t2)/2 ;
    }
    }
    t1 = tr ;
    t2 = m_X ;
    for (i = 1 ;i <= 50 ;i++) {
    th=(t1+t2)/2 ;
    fact = 20.3182−2795/(th+273.15)−1.68*Math.log(th+273.15) ;
    pc = Math.pow(10,fact) ;
    pc = pc/750.01 ;
    lv = 2501.8 − 2.378*th ;
    ph = pc−1.006*(1.01325−pc)*(m_X-th)/(0.622*lv) ;
    delta = t2−t1 ;
    if (ph > pv)
    {
    t2 = th ;
    }
    if (ph <= pv)
    {
    t1 = th ;
    }
    if ( delta < 0.5 )
    {
    th = (t1+t2)/2 ;
    }
    }
    m_X = m_X.toFixed(2) + “ °C”;
    m_Y = m_Y.toFixed(3) + “ g/kg AS”;
    rho = rho.toFixed(3) + “ kg/m3”;
    hr = hrm.toFixed(2) + “ %”;
    h = h.toFixed(3) + “ kj/kg”;
    pv = pv.toFixed(5) + “ bar” ;
    tr = tr.toFixed(2) + “ °C” ;
    th = th.toFixed(2) + “ °C” ;
    ps = ps.toFixed(2) + “ bar” ;
    if (hrm > 100.01) {
    alert(“ The point selected is in the fog zone ”);
    }
    else {
    alert(“ Properties of air :\n \n − Temperature = “ + m_X + ”\n \n − Absolue Humidity = “ +
m_Y + ”\n \n − Relative Humidity = “ + hr + ”\n \n − Specific Enthalpy = “ + h + ”\n \n − Pressure
of Vapour = “ + pv + ”\n \n − Density = “ + rho + ”\n \n − Wet Temperature = “ + th + ”\n \n −
Temperature of Saturation = “ + tr + ”\n\n\n”);
    cordx = event.clientX − 5 ;
    cordy = event.clientY − 5 ;
    document.write(‘<BODY background=“images/diagramme.png”><div id=“image1”
style=“position:absolute; overflow:hidden; left:‘ + cordx + ’px; top:‘ + cordy + ’px; width:5px;
height:5px; border:red 4px solid ”><img src=“images/logo.png” border=3 width=3
height=3></div>’);
    document.write(‘<br><br><br><br><a href=“diagramme psychrometrique.html”> <font
face=“monospace” color=blue>Select another point </font></a>’);
    document.write(‘<br><br><a href=“CALCUL.html”> <font face=“monospace”
color=blue> Back to the graph </font></a>’);
    document.write(“<br><br><br><br><font face=arial size=2>PROPERTIES : <ul><li>
Temperature  = “ + m_X + ”<li> Absolute Humidity  = “ + m_Y + ”<li> Relative Humidity
= “ + hr + ”<li> Specific Enthalpy = “ + h + ”<li> Pressure of Vapour = “ + pv + ”<li> Density
= “ + rho + ”<li> Wet Temperature = “ + th + ”<li> Temperature of Saturation = “ + tr + ”
</font></ul> ”);
    }
    }
    }
    document.onmousemove = donnee ;
    document.onmouseup = donnee ;
    function donnee(e) {
    x = event.screenX;
    y = event.screenY;
    if ( x < 27 || x > 955 || y > 681 || y < 153 )
    {
    window.status = ‘ Temperature = Wet Temperature = Humidity =
Pressure of Vapour = ’ ;
    }
    else {
    x = (x − 173)/14.1 ;
    y = (680 − y)/15.66 ;
    rho = (1.293*273.15*(18/29)*(1+y/1000))/((x+273.15)*((18/29)+y/1000));
    h = 1.006 * (x) + (y/1000) * (2501+1.840*(y));
    pv = (1.01325*(y/1000))/((18/29)+(y/1000)) ;
    facteur = 20.3182−2795/(x+273.15)−1.68*Math.log(x+273.15) ;
    ps = Math.pow(10,facteur) ;
    ps = ps/750.01 ;
    hrm = (pv/ps)*100 ;
    th = 0 ;
    t1 = −50 ;
    t2 = 200 ;
    tr = 0 ;
    for (i = 1 ;i <= 50 ;i++) {
    tl=(t1+t2)/2 ;
    fact = 20.3182−2795/(tl+273.15)−1.68*Math.log(tl+273.15) ;
    pl = Math.pow(10,fact) ;
    pl = pl/750.01 ;
    delta = t2−t1 ;
    if (pl > pv)
    {
    t2 = tl ;
    }
    if (pl <= pv)
    {
    t1 = tl ;
    }
    if ( delta < 0.5 )
    {
    tr = (t1+t2)/2 ;
    }
    }
    t1 = tr ;
    t2 = x ;
    for (i = 1 ;i <= 50 ;i++) {
    th=(t1+t2)/2 ;
    fact = 20.3182−2795/(th+273.15)−1.68*Math.log(th+273.15) ;
    pc = Math.pow(10,fact) ;
    pc = pc/750.01 ;
    lv = 2501.8 − 2.378*th ;
    ph = pc−1.006*(1.01325−pc)*(x-th)/(0.622*lv) ;
    delta = t2−t1 ;
    if (ph > pv)
    {
    t2 = th ;
    }
    if (ph <= pv)
    {
    t1 = th ;
    }
    if ( delta < 0.5 )
    {
    th = (t1+t2)/2 ;
    }
    }
    x = x.toFixed(2) + “ °C”;
    y = y.toFixed(3) + “ g/kg AS”;
    rho = rho.toFixed(3) + “ kg/m3”;
    hr = hrm.toFixed(2) + “ %”;
    h = h.toFixed(3) + “ kj/kg”;
    pv = pv.toFixed(5) + “ bar” ;
    tr = tr.toFixed(2) + “ °C” ;
    th = th.toFixed(2) + “ °C” ;
    ps = ps.toFixed(2) + “ bar” ;
    window.status = ‘ Temperature = ’ + x + ‘ Wet Temperature = ’ + th + ‘ Humidity = ’
+ hr + ‘ Pressure of Vapour = ’ + pv ;
    }
    }
// -->
```

Another aspect of the present disclosure relates to a method for analyzing a graphs and/or physical bodies. In this regard, reference is made to FIG. 7, which depicts a flowchart of an exemplary method in accordance with the present disclosure. As shown, method 700 begins at block 701. At block 702, an input module (IM) and synchronization and display module (SDM) may be executed by a processor. The IM and SDM function as described previously in conjunction with the system, and thus their functions are not reiterated herein. At block 703, the SDM may determine a scaling factor (in pixels) for a unit of each axis of a graph under consideration, as well as the total length (in pixels) for each graph.

At block 704, the SDM may establish one or more reference points in the rendering area of a GUI displayed on a computing device, and correlate such reference point(s) to appropriate portions of the graph under consideration. As noted previously, the SDM may correlate the origin of a graph under consideration with a specific region of a rendering area of a GUI.

At block 705, the IM and SDM may be used to extract data from the graph under consideration by applying the scaling factor(s) determined in block 703 to convert the pixel coordinates of a digital pointer to data points of the graph under consideration. At block 706, the SDM may cause the calculated data points to appear in a reporting area.

The method may then proceed to optional block 707, wherein an optional analysis module may be used to perform one of more analyses on the data extracted from the graph by the SDM. If performed, results of these analyses may also be displayed in the reporting area.

At block 708, the method ends.

Another aspect of the present disclosure relates to systems and methods for extracting data from multiple charts simultaneously. In this regard, it is noted that many graphs encountered in engineering have two independent axes, representing two variables. As a result, it can be difficult to extract data from graphs having more than two axes. This can be problematic in industries where the optimization of multiple variables is desired. As discussed below, the systems and methods of the present disclosure can address this issue by allowing multiple graphs to be analyzed at the same time.

In this aspect, a printed or electronic copy of a first graph is processed in the same manner as described above for the analysis of a single graph. That is, an input module (IM) and synchronization and display module (SDM) are leveraged to determine the length of each axis of the first graph, as well as appropriate scaling factors for each graph. The SDM applies the scaling factors to scale the movement of a digital pointer in a GUI to the movement of an input device. The SDM further establishes one or more reference points in the GUI, which correspond to identify locations in the first graph. The system may then extract data from the first graph by converting the pixel coordinates of the digital pointer in the GUI to data points using the scaling factor, as described above. As noted previously, an electronic copy (e.g., image) of the first printed chart can be displayed in the GUI. For example, an electronic copy of the first graph may be embedded in a GUI, such as the GUI's described above.

The first graph may then be replaced by a printed or electronic copy of a second graph. The second graph may have at least one axis in common with the first graph. That is, the second graph may have an axis in the same units as an axis of the first graph. Alternatively or additionally, the second graph may have at least one axis that is in units that bear a mathematical relationship to the units of at least one axis of the first graph. For convenience, the axes of the first and second graphs that are in the same or mathematically related units are individually and collectively referred to herein as a “common axis” or “common axes.”

Although not required, the common axes of the first and second graphs may be of the same physical length. This may be accomplished, for example, by adjusting the scale of the first or second graph such that their common axes are of the same physical length. Alternatively or additionally, a length adjustment factor may be determined by calculating a ratio of the length of the axes of the first graph to the length of the corresponding axes of the second graph or vice versa. This length adjustment factor may be applied by an SDM to compensate for differences in the physical length of the common axes of the first and second graphs. In any case, like the first graph, an electronic copy of the second graph may be displayed in a second GUI. The second GUI may, for example, be positioned adjacent to the GUI displaying the first graph.

Data may then be extracted from the first and second graphs simultaneously by moving the input device over the second graph. As the input device is moved, a corresponding digital pointer may move in the GUI displaying the electronic copy of the first graph. The SDM may convert the pixel coordinates of the digital pointer to data in the first graph by applying the scaling factor, as previously described. In instances where the second graph is a printed graph, data from the second graph may be gleaned by inspecting the physical location of the input device on the printed second graph. Alternatively or additionally, data in the second graph may be calculated from the data extracted from the first graph, e.g., using known mathematical relationships between the data in the first and second graphs. Similarly, data may be extracted from the second graph in the same manner as data is extracted from a single graph, as discussed above. In such a case, when an input device is moved over the second graph, the system may extract data from the second graph using the physical position of the mouse, while simultaneously extracting data from the first graph using the position of the digital pointer.

In instances where the first and second graphs are both in electronic form, each graph may be displayed in its own rendering area, and the position of a digital pointer on the second graph may be correlated to the position of a digital pointed on the first graph. Data may then be extracted from the first and second graphs based on the position of their respective digital pointers.

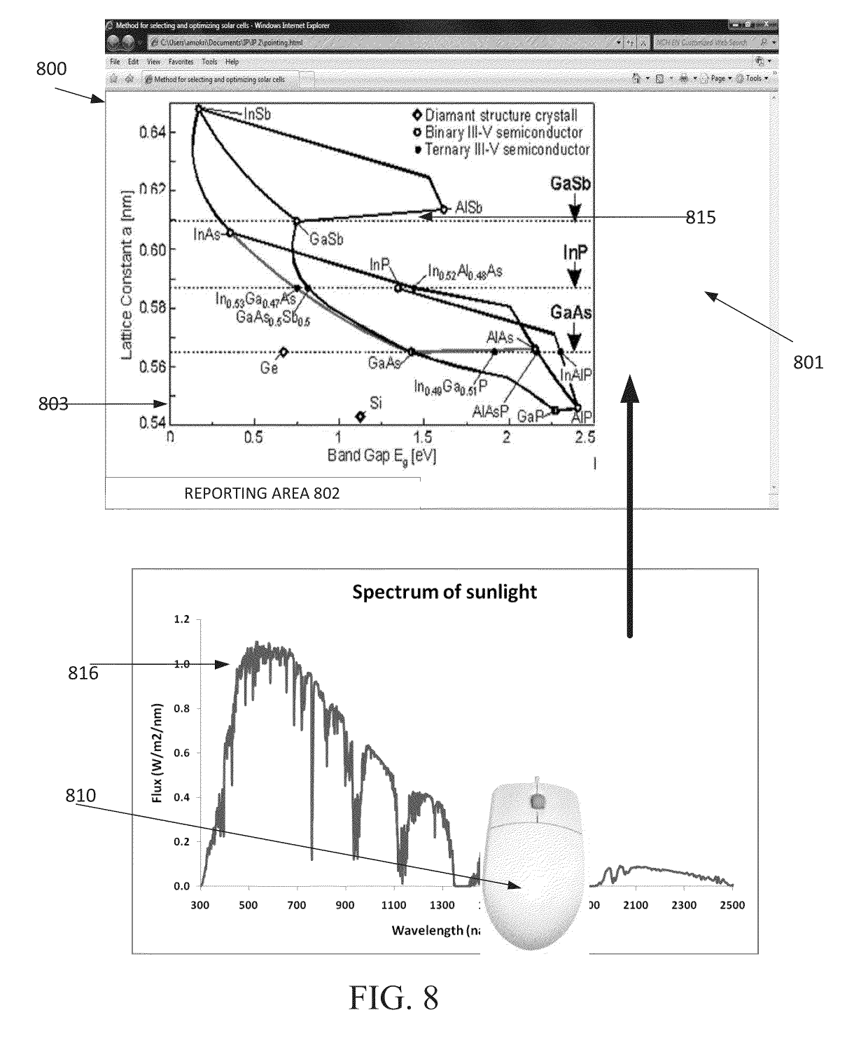

To illustrate this process, the specification will now describe a non-limiting example wherein a system in accordance with the present disclosure is used to simultaneously analyze two graphs that are useful in the development and optimization of solar cells. More particularly, the first graph in this example plots energy bandgap versus the lattice constant of a solar cell material, and the second graph plots intensity versus wavelength. These graphs are shown in FIG. 8 as first graph 815 and second graph 816, respectively. Engineers in this field might use the first graph to determine the energy bandgap and lattice constant of a cell material. Once those two parameters are determined, the second graph may be used to determine which spectral photons and how much incident solar energy can be converted to electricity by the solar cell under consideration.

In this regard, reference is made to FIG. 8, which depicts an exemplary system for analyzing multiple graphs at the same time. In this example, an SDM (not shown) is executed by a processor, causing graphical user interface (GUI) 800 to be displayed on a display of a computing device (not shown). In this case, printed copy of first graph 815 was converted into an image 803, which was displayed within rendering area 801 of GUI 800. Consistent with the foregoing discussion regarding data extraction from a single graph, image 803 was aligned with one or more reference points. Input device 810 was used to trace the x and y axes of the printed copy of first graph 815. As the input device 810 moved, SDM monitored the corresponding movement of a digital pointer in rendering area 801. The SDM then determined appropriate the total length of and appropriate scaling factors for each axis of first graph 815. Data was then extracted from first graph 815 using the methods described above for the analysis of a single chart.

The printed copy of first graph 815 was then replaced with a printed copy of second graph 816. As described above and shown in FIG. 8, second graph 816 plots flux versus wavelength (nm). The wavelength of second graph 816 was mathematically related to the energy bandgap in first graph 815 by the function:

1240/EB=W(nm)

Where EB is the energy bandgap of first graph 815, W is the wavelength of second graph 816, and 1240 is a constant. Although not apparent from FIG. 8, it is noted that the physical length of the x axis of second graph 816 was the same as the physical length of the x axis of first graph 815.

Input device 810 was then moved over the printed copy of second graph 816. This movement caused a corresponding movement of a digital pointer (again, not shown) over the image 803 of first graph 815. As input device 810 moved in this manner, the SDM applied the scaling factors (determined for first graph 815 as discussed above) to convert the pixel coordinates of the digital pointer on graph 1 to data in graph 1. In this case, the data extracted from first graph 815 was displayed in reporting area 802, e.g., in a status bar of GUI 800. The SDM also correlated the extracted data values with the corresponding cell material (shown in first graph 815), and displayed that material in reporting area 802.

The SDM in this example was also configured to synchronously or asynchronously utilize the data extracted from first graph 815 to calculate corresponding data in second graph 816. In this case, the SDM was configured to calculate the wavelength of second graph 816 using the energy bandgap data extracted from first graph 815, e.g., by rearranging the foregoing mathematical function describing the relationship between energy bandgap and wavelength. The fourth variable, flux (shown in second graph 816), could also be calculated using Planck's law. The SDM caused the calculated data to appear in reporting area 802.

In this way, the systems of the present disclosure can enable the determination of 3, 4, or more variables, simply by moving input device 810. Simultaneous optimization of such variables may be performed in the same manner, i.e., by moving input device 810 and monitoring the data reported in reporting area 802.

FIG. 9 depicts an example in which an input device is used to measure one or more features of a physical body. In this example, mouse 201 having optical sensor 204 coupled thereto is used as the input device. As in the analysis of a graph, one or more reference points may be established on object 901, and such reference points may be correlated with points in GUI for the analysis of a physical body. The distance in pixels may then be determined by moving optical sensor 904 between the reference points on object 901. The system may then determine a scaling factor to scale the movement of optical sensor 901 to the movement of a digital pointer within the GUI. The system may then calculated various properties of physical object 901 by monitoring the movement of the digital pointer and applying the relevant scaling factor.

In this way, the systems of the present disclosure can enable measurement of complex lines, e.g., curves, s-curves, sawtooths, and the like. Such measurements may be significantly more accurate than hand measurements, as they underluying calculations are based on pixels, instead of larger units such as millimeters. The systems may also enable the measurement of the surface of complex shapes, including those with non-flat surfaces. Moreover, the data from the system may be analyzed to extrapolate even more information from the physical body. Without limitation, such systems may have significant practical utility in mechanical or carpenters shops, where measurements are of particular importance.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. A system, comprising:
a processor, an input device, and a memory having a synchronization and display module (SDM) instructions stored therein, said SDM instructions when executed by said processor cause said processor to perform the following functions comprising:
determine at least one scaling factor for one or more dimensions of a first graph or physical body, said at least one scaling factor corresponding to the number of pixels a digital pointer moves in response to movement of said input device by a physical length of a unit of said first graph or physical body; and
extract data from said first graph or physical body by applying said at least one scaling factor to convert pixel coordinates of said digital pointer to data of said first graph or physical body.

2. The system of claim 1, wherein said SDM instructions when executed by said processor further cause said processor to determine the total length in pixels of at least one axis of said first graph.

3. The system of claim 1, further comprising a display, wherein said SDM instructions when executed by said processor cause a graphical user interface to appear on said display, said graphical user interface comprising a rendering area; and
said digital pointer is displayed within said rendering area.

4. The system of claim 3, wherein said SDM instructions when executed further cause said processor to display an image of said first graph or physical body within said rendering area.

5. The system of claim 3, wherein said SDM instructions when executed further cause said processor to identify one or more reference points within said rendering area, and correlate said one or more reference points with one or more selected points on said first graph or physical body.

6. The system of claim 1, wherein said input device is selected from the group consisting of a computer mouse, a trackball, a touchpad, a touch screen, a stylus, a game controller, a gamepad, a paddle, a joystick, a remote control, a video input device and combinations thereof.

7. The system of claim 1, wherein said first graph is in printed or electronic form.

8. The system of claim 1, wherein said SDM instructions when executed further cause said processor to determine data values of a second graph based at least in part on data extracted from said first graph.

9. The system of claim 8, wherein said second graph is in printed or electronic form.

10. The system of claim 9, wherein said first graph and said second graph comprise at least one common axis.

11. A method, comprising:
determining at least one scaling factor for one or more dimensions of a first graph or physical body with a computing device comprising an input device, said at least one scaling factor corresponding to the number of pixels a digital pointer moves in response to movement of said input device by a physical length of a unit of said first graph or physical body; and
converting with said at least one scaling factor pixel coordinates of said digital pointer to data of said first graph or physical body.

12. The method of claim 11, further comprising determining the total length in pixels of at least one axis of said first graph.

13. The method of claim 11, wherein said computing device further comprises a display, the method further comprising:
displaying a graphical user interface on said display, said graphical user interface comprising a rendering area;
displaying said digital pointer within said rendering area.

14. The method of claim 13, further comprising displaying an image of said first graph or physical body within said rendering area.

15. The method of claim 13, further comprising identifying one or more reference points within said rendering area, and correlating said one or more reference points to one or more selected points on said first graph or physical body.

16. The method of claim 11, wherein said input device is selected from the group consisting of a computer mouse, a trackball, a touchpad, a touch screen, a stylus, a game controller, a gamepad, a paddle, a joystick, a remote control, a video input device and combinations thereof.

17. The method of claim 11, wherein said first graph is in printed or electronic form.

18. The method of claim 11, further comprising determining data values of a second graph based at least in part on data extracted from said first graph.

19. The method of claim 18, wherein said second graph is in printed or electronic form.

20. The method of claim 19, wherein said first graph and said second graph comprise at least one common axis.
